(19) United States
(12) Patent Application Publication
(10) Pub. No.: US 2005/0250897 A1
(43) Pub. Date: Nov. 10, 2005

(54) Conductive plastic composition

(75) Inventors: Feng-Jeng Huang, Tainan County (TW); Chih-Nan Chu, Tainan City (TW)

Correspondence Address: SENNIGER POWERS LEAVITT AND ROEDEL, ONE METROPOLITAN SQUARE, 16TH FLOOR, ST LOUIS, MO, 63102, US

(73) Assignee: Chi Lin Technology Co., Ltd.

(21) Appl. No.: 10/792,316

(22) Filed: Mar. 3, 2004

(51) Int. Cl. C08K 3/00

(52) U.S. Cl. 524/505; 428/500

(57) ABSTRACT

The present invention provides a conductive plastic composition comprising: (I) a copolymer comprising the styrene block and the conjugated diene block; (II) a copolymer comprising the styrene block and the acrylate type block; and (III) carbon black; said composition containing from 0.1 to 50 parts by weight of the copolymer (II) comprising the styrene block and the acrylate type block per 100 parts by weight of the copolymer (I) comprising the styrene block and the conjugated diene block; and from 5 to 50 parts by weight of the carbon black (III) per 100 parts by weight of the copolymer (I) comprising the styrene block and the conjugated diene block.

### BACKGROUND OF THE INVENTION

1. Field of the Invention

The invention relates to a plastic composition. More particularly, the invention relates to a conductive plastic composition. Said conductive plastic composition is useful in producing a sheet in packaging containers for semiconductors such as IC and electronic parts.

2. Description of the Related Art

For packaging and transporting electronic parts or IC, injection-molded trays, vacuum-formed trays, magazines, carrier tapes (referred to also as embossed carrier tapes), etc. have been used. To prevent breakage of electronic parts, such as IC, due to static electricity of friction or isolation, a packaging container comprising a thermoplastic resin component and an electroconductive component has been developed. The thermoplastic resin component usually comprises an acrylonitrile-butadiene-styrene type resin, a polystyrene type resin, a poly vinyl chloride resin, or a styrene-co-butadiene resin. As electroconductive components, fine metal powder, carbon fiber, and electroconductive carbon black are used. With fine metal powder and carbon fiber, adequate electroconductivity can be obtained with a small amount of incorporation, but the moldability will thereby substantially deteriorate, and it is difficult to uniformly disperse them. Furthermore, a skin layer composed solely of the resin component is likely to form on the surface of a molded product, and it is difficult to obtain a constant surface resistivity.

Carbon black can be uniformly dispersed by properly selecting the kneading conditions, etc., whereby a constant surface resistivity can be easily obtained. For this reason, carbon black is most commonly employed. However, carbon black is required to be incorporated in a large amount, whereby the fluidity or the moldability tends to deteriorate.

Several modifications have been made to resolve the problem.

Kishida et al., U.S. Pat. No. 4,478,903, discloses a composite plastic sheet having conductive surface. In such conductive surface, a conductive surface layer is made of a resin selected from the group consisting of a polystyrene base resin and an acrylonitrile-butadiene-styrene base resin, said conductive surface layer containing 5 to 50%, by weight, of carbon black and having a specific surface resistance of not more than 10¹⁰ Ω.

Miyakawa et al., U.S. Pat. No. 5,747,164, also discloses a conductive composite plastic sheet and container. Said conductive composite plastic sheet comprises an electroconductive composition consisting essentially of (A) at least one thermoplastic resin selected from the group consisting of a polyphenylene ether resin combined with a polystyrene resin; a polystyrene resin; and an acrylonitrile/butadiene/styrene resin; (B) carbon black; and (C) an olefin type resin, and wherein the melt flow index of said olefin type resin is at least 0.1 g/10 min as measured at 190° C. under a load of 2.16 kg in accordance with JIS K-7210 or (C1) a resin obtained by hydrogenation of a styrene/diene block copolymer. Said electroconductive composition contains from 5 to 50 parts by weight of (B) the carbon black per 1000 parts by weight of (A) the thermoplastic resin, and from 1 to 30 parts by weight of (C) the olefin type resin or (C1) the resin obtained by hydrogenation of a styrene/diene block copolymer, per 100 parts by weight of the total amount of (A) the thermoplastic resin and (B) the carbon black.

Kosugi et al., U.S. Pat. No. 6,485,832, also discloses an electroconductive sheet comprising an acrylonitrile-butadiene-styrene copolymer type resin and/or a polystyrene type resin a surface layer of an electroconductive composition comprising a polycarbonate type resin and from 5 to 50 wt % of carbon black.

However, the container made of modification of polystyrene type resin by rubber grafting has the defect of polluting the cargo carried thereon because of black carbon detachment. In order to overcome the defect, a modifier such as olefin type resins (e.g., PE, PP) that is not completely compatible with polystyrene type resin is added. However, the strength and mechanical instability are not satisfied and will lead to cargo skipping when transporting.

### SUMMARY OF THE INVENTION

The invention provides a conductive plastic composition comprising:
(I) a copolymer comprising a styrene block and a conjugated diene block;
(II) a copolymer comprising a styrene block and an acrylate type block; and (III) carbon black;
said composition containing from 0.1 to 50 parts by weight of the copolymer (II) comprising the styrene block and the acrylate type block per 100 parts by weight of the copolymer (I) comprising the styrene block and the acrylate type block; and from 5 to 50 parts by weight of the carbon black (III) per 100 parts by weight of the copolymer (I) comprising the styrene block and the conjugated diene block.

Preferably, the composition according to the invention further comprises (IV) an olefin type resin; and the composition contains from 0.1 to 30 parts by weight of the olefin type resin (IV) per 100 parts by weight of (I) the copolymer comprising the styrene block and the conjugated diene block.

Preferably, the composition further comprises (V) a polystyrene base resin; and the composition contains from 1 to 20 parts by weight of (V) the polystyrene base resin (V) per 100 parts by weight of the copolymer (I) comprising the styrene block and the conjugated diene block.

In another aspect, the invention provides a conductive plastic sheet, which is made of the composition according to the invention.

In still another aspect, the invention provides a conductive composite plastic sheet comprising a substrate layer and a conductive surface layer laminated on at least one side of the substrate layer, wherein the surface layer is made of the conductive plastic sheet according to the invention that comprises the composition according to the invention.

### DETAILED DESCRIPTION OF THE INVENTION

The present invention provides a novel conductive plastic composition for preparing a conductive plastic sheet that has good stripping strength, mechanical strength and surface resistivity. Furthermore, the composition according to the invention prevents carbon black detachment. A container for packaging and transporting IC, electronic parts using IC or electronic parts made of the conductive plastic sheet according to the invention prevents the cargo carried thereon from skipping by improving the adhesive strength attachment between the container and cargo and also prevents the pollution of carbon black.

The present invention provides a conductive plastic composition comprising:

(I) a copolymer comprising a styrene block and a conjugated diene block;
(II) a copolymer comprising a styrene block and an acrylate type block; and
(III) carbon black;
said composition containing from 0.1 to 50 parts by weight of the copolymer (II) comprising the styrene block and the acrylate type block per 100 parts by weight of the copolymer (I) comprising the styrene block and the conjugated diene block; and from 5 to 50 parts by weight of the carbon black (III) per 100 parts by weight of the copolymer (I) comprising the styrene block and the conjugated diene block.

In a preferred embodiment of the invention, the copolymer (I) comprising the styrene block and the conjugated diene block is the one wherein the conjugated diene block is butadiene or isoprene. In a more preferred embodiment, it is a styrene and butadiene copolymer, or a styrene and isoprene copolymer. Particularly, the styrene and butadiene copolymer provides quite good robustness, softness and bending quality, and further provides adhesion strength between the container and cargo. Furthermore, the attachment to carbon black is stronger than the conventional acrylonitrile-butadiene-styrene and high impact polystyrene resins; it resolves the problem of carbon black detachment in the prior art. Such a block copolymer may, for example, be a branched star block copolymer as disclosed in U.S. Pat. No. 3,281,383 or a linear block copolymer having at least three blocks, as represented by, e.g., (S1)-(Bu)-(S2), wherein each of S1 and S2 is a block formed by styrene, and Bu is a block formed by butadiene or isoprene.

Furthermore, when at least two different block copolymers comprising a styrene block and the conjugated diene block are incorporated into the composition in the present invention, it is preferred that at least one of them is (Ia) a star block copolymer having a styrene content of from 50 to 95 wt %, and at least one of other block copolymers is (Ib) a star or linear block copolymer having a styrene content of from 5 to 50 wt %. In many cases, this branched chain star block copolymer contains a straight chain block copolymer from the nature of the process for its production, but it is unnecessary to remove such a straight chain block copolymer, and their mixture may be employed as it is.

According to the invention, the copolymer (II) comprising the styrene block and the acrylate type block is used to provide mechanical strength. Moreover, the copolymer (II) comprising the styrene block and the acrylate type block adjusts the adhesion strength and maintains the adhesion strength, stability, fluidity and the moldability. In a preferred embodiment of the invention, the acrylate block of the copolymer (II) is selected from the group consisting of methyl acrylate, methyl methacrylate, n-butyl acrylate, and the mixture thereof. In another aspect, the copolymer (II) has an acrylate content of from 10 to 60 wt %. According to the invention, the composition contains from 0.1 to 50 parts by weight of the copolymer (II) comprising the styrene block and the acrylate type block per 100 parts by weight of the copolymer (I) comprising the styrene block and the conjugated diene block. If the content of the copolymer (II) comprising the styrene block and the acrylate type block is more than 50 parts, the stripping strength between the container and cargo is deteriorated.

In a preferred embodiment of the invention, the carbon black (III) is selected from the group consisting of furnace black, channel black, super conductive furnace, and electric conductive furnace. More preferably, the carbon black (III) has a large specific surface area and whereby a high level of electroconductivity can be obtained with a small amount of incorporation to the resin. For example, it may be high structure barbon black of Degussa®, Carbot®, or Ketjen black®. The amount of carbon black to be incorporated is an amount whereby the surface resistivity in a state of from 10² to 10¹⁰ Ω, and preferably from 10⁴ to 10⁸ Ω. If the surface resistivity exceeds 10¹⁰ Ω, no adequate antistatic effect can be obtained, and if it is less than 10² Ω, the power generating ability tends to be so good that IC will be destroyed thereby. The amount of the carbon black (III) is preferably from 5 to 50 parts by weight per 100 parts by weight of the copolymer (I) comprising the styrene block and the conjugated diene block.

If the amount is less than 5 parts by weight, no adequate electroconductivity can be obtained, and the surface resistivity will increase. On the other hand, if it exceeds 50 parts by weight, uniform dispersion into the resin tends to be difficult, the moldability tends to substantially deteriorate, and the properties such as mechanical strength tend to deteriorate.

In a preferred embodiment of the invention, the composition according to the invention further comprises (IV) an olefin type resin.

According to the invention, the olefin type resin (IV) to be used in the present invention may, for example, be a homopolymer of ethylene or propylene, a copolymer composed mainly of ethylene or propylene, or a blend product thereof. Preferably, a polyethylene type resin is represented by a low density polyethylene resin, a high density polyethylene resin, a linear low density polyethylene resin, or an ethylene/α-olefin copolymer resin. More preferably, the olefin type resin (IV) is selected from the group consisting of an ethylene and vinyl acetate copolymer, an ethylene and α-olefin copolymer, an ethylene and methacrylate copolymer, and the mixtures thereof. Most preferably, the olefin type resin (IV) is an ethylene and vinyl acetate copolymer. In an embodiment of the invention, the amount of vinyl acetate is from 3 to 30%. If the amount is less than 3%, the adhesion strength is not satisfied. On the other hand, if the amount is more than 30%, the composition is hard to handle, and the compatibility between the copolymer (I) comprising the styrene block and the conjugated diene block is also not qualified. In another aspect, the amount of the olefin type resin (IV) is preferably from 0.1 to 30 parts by weight, per 100 parts by weight of the total amount of the copolymer (I) comprising the styrene block and the conjugated diene block. If it exceeds 30 parts by weight, it tends to lower the adhesion strength. In another preferred embodiment of the invention, the composition according to the invention further comprises (V) a polystyrene base resin, and the composition contains from 1 to 20 parts by weight of the polystyrene base resin (V) per 100 parts by weight of the copolymer (I) comprising the styrene block and the conjugated diene block. In a preferred embodiment of the invention, the polystyrene base resin is selected from the group consisting of a high impact polystyrene resin, a blended polystyrene base resin, and the mixtures thereof.

Furthermore, to the composition according to the present invention, it is possible to incorporate various additives such as a lubricant, a plasticizer, a processing assistant, a reinforcing agent (a resin modifier), or other resin components to improve the flow properties of the composition and the dynamic properties of the molded product, and the mixture thereof.

In order to obtain adequate moldability, the melt flow index of the copolymer (I) comprising the styrene block and the conjugated diene block to be used in the present invention is at least 0.1 g/10 min and preferably 0.5 g/10 min as measured at 200° C. under a load of 5 kg. The melt flow index of the copolymer (II) comprising the styrene block and the acrylate type block to be used in the present invention is at least 0.1 g/10 min and preferably 0.5 g/10 min as measured at 200° C. under a load of 5 kg. The melt flow index of the olefin type resin (IV) to be used in the present invention is at least 0.1 g/10 min and preferably 0.5 g/10 min as measured at 200° C. under a load of 5 kg.

In order to knead the composition, the starting materials may be kneaded all at once or may be kneaded stepwise, and the kneaded products are finally put together and kneaded. The kneading can be achieved by the conventional machines such as Banbury® or Kneader® twin-screw extruder.

The present invention also provides a conductive plastic sheet that comprises the conductive plastic sheet according to the invention.

Preferably, the conductive plastic sheet according to the invention has a surface resistivity of from 10² to 10¹⁰ Ω.

The present invention also provides a conductive composite plastic sheet, comprising a substrate layer and a conductive surface layer laminated on at least one side of the substrate layer, wherein the surface layer is made of the conductive plastic sheet that comprises the composition according to the invention.

According to the invention, the substrate layer comprises a thermoplastic resin. For example, the thermoplastic resin is a polystyrene type resin, an acrylonitrile-butadiene-styrene resin, a polyphenylene resin, or a polycarbonate resin. In one embodiment of the invention, the thickness of the sheet layer is between 0.1 to 3.0 mm. In another aspect, the thickness of the surface layer is 2 to 80% of that of the conductive composite plastic sheet.

The present invention also provides an electroconductive composite plastic container obtained by forming the conductive composite plastic sheet according to the invention by a process selected from the group consisting of pressure forming, vacuum forming and thermoforming.

The following examples are given for the purpose of illustration only and are not intended to limit the scope of the present invention.

### EXAMPLES 1 to 5 and COMPARATIVE EXAMPLES 1 to 3

The contents of the compositions are listed in Table. 1. The material of the substrate layer is polystyrene resin. The respective materials were weighed and uniformly mixed by a high speed mixing machine, then kneaded by means of a φ 125 mm and φ 40 mm vented twin-screw extruder and pelletized by a strand cut method to obtain an electroconductive sheet. The substrate layer was laminated with the surface layers on each side to form a 0.3 mm sheet, wherein the thickness ratio of the surface layer: substrate layer: surface layer was 1:8:1.

TABLE 1

| | Surface layer (weight %) | | | | |
|---|---|---|---|---|---|
| | | | | Carbon | |
| | HIPS(V) | MS(II) | SB(I) | black(III) | Olefin(IV) |
| Ex. 1 | 0 | 0 | 100 | 8.8 | 0.0 |
| Ex. 2 | 0 | 0 | 100 | 9.9 | 12.4 |
| Ex. 3 | 0 | 11 | 89 | 8.8 | 0.0 |
| Ex. 4 | 12 | 10 | 90 | 9.9 | 0.0 |
| Ex. 5 | 0 | 25 | 75 | 9.9 | 0.0 |
| Comp. | 50 | 0 | 50 | 8.8 | 0.0 |
| Ex. 1 | | | | | |
| Comp. | 100 | 0 | 0 | 8.8 | 0.0 |
| Ex. 2 | | | | | |
| Comp. | 100 | 0 | 0 | 10.5 | 13.0 |
| Ex. 3 | | | | | |

HIPS (high impact polystyrene resin): POLYEREX PH-88S (CHI MEI CORPORATION ®), HP9450 (FORMOSA CHEMICALS & FIBER CORPORATION ®), 851S (KAOFU CHEMICAL CORPORATION ®)
MS (methacrylate-styrene copolymer): ACRYSTEX PM-200 (CHI MEI CORPORATION ®), MM-20 (A&L ®)
SB (Styrene-butadiene copolymer): PB5903 (CHI MEI CORPORATION ®), KR-03 (PHILIPS ®), BASF ®, ASAHI ® Asaflex, DANKA ®
Carbon black: KETJENBLACK EC-300 (KETJEN BLACK INTERNATION COMPANY ®), XE-2B (DEGUSSA ®)
Olefin: LDPE F-2201 (FORMOSA PLASTIC CORPORATION ®)

The properties of Examples 1 to 5 and Comparative Examples 1 to 3 were evaluated according to the methods listed below:

Surface resistivity: In accordance with ASTM D-257, surface resistivity was taken in its detectable range.

Stripping strength: The strips having a width of 25 mm prepared from the sheets of Examples 1 to 5 and Comparative Examples 1 to 3 were shaped with cover tape and carrier tape by means of a carrier tape shaping machine (TP-1000 manufactured by E&R®), and the adhesive strength of the cover tape and carrier tape were measured by means of a stripping test machine (JE PFT-500 manufactured by OVERTOP TECHNOLOGY CO., LTD.) in accordance with the EIA-481 method. In addition, the adhesive strength of the cover tape was and carrier tape was measured when the shaped carrier tape under a test of constant temperature of 60° C. and constant relative humidity of 65% in three days, so as to evaluate the aging properties of the materials.

Mechanical properties: Each of the sheets of Examples 1 to 5 and Comparative Examples 1 to 3 was cut into five strips, and had a width of 2.5 cm and a length of 30 cm in accordance with the ASTM D-882 method in their transverse and longitudinal direction. The mean value of the transverse and longitudinal tensile strength and the elongation of the five strips were obtained by a universal tensile test machine.

The results are listed in Table 2:

| | | | | | | | Comp. | Comp. | Comp. |
|---|---|---|---|---|---|---|---|---|---|
| Properties | | Ex. 1 | Ex. 2 | Ex. 3 | Ex. 4 | Ex. 5 | Ex. 1 | Ex. 2 | Ex. 3 |
| Surface resistivity | | 5.2 × 10⁴ | 6.2 × 10⁴ | 5.6 × 10⁴ | 4.9 × 10⁴ | 4.5 × 10⁴ | 6.3 × 10⁴ | 5.8 × 10⁴ | 5.6 × 10⁴ |
| (Ohms/Square) | | | | | | | | | |
| Room | Max. | 88 | 96 | 89 | 66 | 57 | 31 | 40 | 30 |
| temperature | Min. | 64 | 68 | 61 | 42 | 34 | 15 | 22 | 14 |
| Stripping | Mean | 74 | 82 | 75 | 52 | 47 | 21 | 30 | 21 |
| strength (g) | Range | 24 | 28 | 28 | 24 | 23 | 16 | 18 | 16 |
| Aging × 3 | Max. | 75 | 82 | 77 | 53 | 43 | 24 | 26 | 23 |
| [symbol] | Min. | 55 | 53 | 53 | 32 | 25 | 10 | 12 | 11 |
| | Mean | 62 | 65 | 51 | 40 | 33 | 15 | 18 | 16 |
| | Range | 20 | 29 | 24 | 21 | 18 | 14 | 14 | 12 |
| Tensile | MD | 240 | 225 | 250 | 245 | 255 | 250 | 260 | 255 |
| strength | TD | 210 | 205 | 225 | 220 | 220 | 220 | 235 | 230 |
| (Kg/cm²) | | | | | | | | | |
| Elongation | MD | 45 | 30 | 30 | 35 | 25 | 20 | 15 | 20 |
| (%) | TD | 35 | 25 | 25 | 30 | 20 | 15 | 10 | 10 |

According to Table 2, the surface resistivity of Examples 1 to 5 is almost the same as that of Comparative Examples 1 to 3. On the other hand, the stripping strength of Examples 1 to 5 is better than Comparative Examples 1 to 3.

Also shown in Table 2, comparing Example 1 with Example 3, which is added with 11 weight % of MS, the tensile strength increased by 4%. Similarly, adding MS also strengthened the tensile strength in Examples 2, 4 and 5. The strong tensile strength helps maintain the stiffness of products and moldability. On the other hand, adding excessive amount of MS leads to stripping strength loss. In the aspect of elongation, each of Examples 1 to 5 is superior to Comparative Examples 1 to 3. It evidenced that the conductive plastic sheet improves ductility and the deficiency rate is lowered thereby. Furthermore, in the aspect of aging, the stripping strength of each of Examples 1 to 5 is also better than that of Comparative Examples 1 to 3.

While embodiments of the present invention have been illustrated and described, various modifications and improvements can be made by persons skilled in the art. It is intended that the present invention is not limited to the particular forms as illustrated, and that all the modifications not departing from the spirit and scope of the present invention are within the scope as defined in the appended claims.

1. A conductive plastic composition comprising:
(I) a copolymer comprising a styrene block and a conjugated diene block;
(II) a copolymer comprising a styrene block and an acrylate type block; and
(III) carbon black;
said composition containing from 0.1 to 50 parts by weight of the copolymer (II) comprising the styrene block and the acrylate type block per 100 parts by weight of the copolymer (I) comprising the styrene block and the conjugated diene block; and from 5 to 50 parts by weight of the carbon black (III) per 100 parts by weight of the copolymer (I) comprising the styrene block and the conjugated diene block.

2. The composition according to claim 1, wherein the conjugated diene block of the copolymer (I) comprising the styrene block and the conjugated diene block is butadiene or isoprene.

3. The composition according to claim 1, wherein the copolymer (I) comprising the styrene block and the conjugated diene block comprises at least one (Ia) a star block having a styrene content of from 50 to 95 wt %, and at least another one (Ib) a star or linear block having a styrene content of from 5 to 50 wt %.

4. The composition according to claim 1, wherein the acrylate type block of the copolymer (II) comprising the styrene block and the acrylate type block is selected from the group consisting of methyl acrylate, methyl methacrylate, n-butyl acrylate, and the mixture thereof.

5. The composition according to claim 1, wherein the copolymer (II) comprising the styrene block and the acrylate type block has an acrylate content of from 10 to 60 wt %.

6. The composition according to claim 1, wherein the carbon black (III) is selected from the group consisting of furnace black, channel black, super conductive furnace, and electric conductive furnace.

7. The composition according to claim 1 further comprising (IV) an olefin type resin; and the conductive plastic composition contains from 0.1 to 30 parts by weight of the olefin type resin (IV) per 100 parts by weight of the copolymer (I) comprising the styrene block and the conjugated diene block.

8. The composition according to claim 7, wherein the olefin type resin (IV) is a copolymer of ethylene and α-olefin type resin.

9. The composition according to claim 7, wherein the olefin type resin (IV) is selected from the group consisting of an ethylene and vinyl acetate copolymer, an ethylene and α-olefin copolymer, an ethylene and methacrylate copolymer, and the mixtures thereof.

10. The composition according to claim 7, wherein the olefin type resin (IV) is an ethylene and vinyl acetate copolymer.

11. The composition according to claim 10, wherein the amount of vinyl acetate is from 3 to 30%.

12. The composition according to claim 1, further comprising (V) a polystyrene base resin; wherein the conductive plastic composition contains from 1 to 20 parts by weight of the polystyrene base resin (V) per 100 parts by weight of the copolymer (I) comprising the styrene block and the conjugated diene block.

13. The composition according to claim 12, wherein the polystyrene base resin (V) is selected from the group consisting of a high impact polystyrene resin, a blended polystyrene base resin, and the mixtures thereof.

14. The composition according to claim 1, further comprising an additive.

15. The composition according to claim 14, wherein the additive is selected from the group consisting of a lubricant, a plasticizer, a processing assistant, a reinforcing agent and other resin components to improve the flow properties of the composition and the dynamic properties of a molded product, and the mixture thereof.

16. A conductive plastic sheet, comprising the composition according to claim 1.

17. A conductive plastic sheet, comprising the composition according to claim 2.

18. A conductive plastic sheet, comprising the composition according to claim 3.

19. A conductive plastic sheet, comprising the composition according to claim 4.

20. A conductive plastic sheet, comprising the composition according to claim 5.

21. A conductive plastic sheet, comprising the composition according to claim 6.

22. A conductive plastic sheet, comprising the composition according to claim 7.

23. A conductive plastic sheet, comprising the composition according to claim 8.

24. A conductive plastic sheet, comprising the composition according to claim 9.

25. A conductive plastic sheet, comprising the composition according to claim 10.

26. A conductive plastic sheet, comprising the composition according to claim 11.

27. A conductive plastic sheet, comprising the composition according to claim 12.

28. A conductive plastic sheet, comprising the composition according to claim 13.

29. A conductive plastic sheet, comprising the composition according to claim 14.

30. A conductive plastic sheet, comprising the composition according to claim 15.

31. The conductive plastic sheet according to claim 16, which has a surface resistivity of from 10² to 10¹⁰ Ω.

32. A conductive composite plastic sheet comprising a substrate layer and a conductive surface layer laminated on at least one side of the substrate layer, wherein the surface layer comprises the composition according to claim 1.

33. A conductive composite plastic sheet comprising a substrate layer and a conductive surface layer laminated on at least one side of the substrate layer, wherein the surface layer comprises the composition according to claim 2.

34. A conductive composite plastic sheet comprising a substrate layer and a conductive surface layer laminated on at least one side of the substrate layer, wherein the surface layer comprises the composition according to claim 3.

35. A conductive composite plastic sheet comprising a substrate layer and a conductive surface layer laminated on at least one side of the substrate layer, wherein the surface layer comprises the composition according to claim 4.

36. A conductive composite plastic sheet comprising a substrate layer and a conductive surface layer laminated on at least one side of the substrate layer, wherein the surface layer comprises the composition according to claim 5.

37. A conductive composite plastic sheet comprising a substrate layer and a conductive surface layer laminated on at least one side of the substrate layer, wherein the surface layer comprises the composition according to claim 6.

38. A conductive composite plastic sheet comprising a substrate layer and a conductive surface layer laminated on at least one side of the substrate layer, wherein the surface layer comprises the composition according to claim 7.

39. A conductive composite plastic sheet comprising a substrate layer and a conductive surface layer laminated on at least one side of the substrate layer, wherein the surface layer comprises the composition according to claim 8.

40. A conductive composite plastic sheet comprising a substrate layer and a conductive surface layer laminated on at least one side of the substrate layer, wherein the surface layer comprises the composition according to claim 9.

41. A conductive composite plastic sheet comprising a substrate layer and a conductive surface layer laminated on at least one side of the substrate layer, wherein the surface layer comprises the composition according to claim 10.

42. A conductive composite plastic sheet comprising a substrate layer and a conductive surface layer laminated on at least one side of the substrate layer, wherein the surface layer comprises the composition according to claim 11.

43. A conductive composite plastic sheet comprising a substrate layer and a conductive surface layer laminated on at least one side of the substrate layer, wherein the surface layer comprises the composition according to claim 12.

44. A conductive composite plastic sheet comprising a substrate layer and a conductive surface layer laminated on at least one side of the substrate layer, wherein the surface layer comprises the composition according to claim 13.

45. A conductive composite plastic sheet comprising a substrate layer and a conductive surface layer laminated on at least one side of the substrate layer, wherein the surface layer comprises the composition according to claim 14.

46. A conductive composite plastic sheet comprising a substrate layer and a conductive surface layer laminated on at least one side of the substrate layer, wherein the surface layer comprises the composition according to claim 15.

47. A conductive composite plastic sheet comprising a substrate layer and the conductive surface layer according to claim 31, wherein the conductive layer is laminated on at least one side of the substrate layer.

48. An electroconductive composite plastic container obtained by forming the conductive composite plastic sheet according to claim 32 by a process selected from the group consisting of pressure forming, vacuum forming and thermoforming.
